(19) United States
(12) Patent Application Publication
(10) Pub. No.: US 2024/0204287 A1
(43) Pub. Date: Jun. 20, 2024

(54) BATTERY WITH OPTIMIZED TEMPERATURE CONTROLLABILITY

(71) Applicant: Volkswagen Aktiengesellschaft, Wolfsburg (DE)

(72) Inventors: Benjamin BEDUERFTIG, Ulm (DE); Bastian SCHAAR, Braunschweig (DE); Anish GAUSH, Lengede (DE); Marvin CZECH, Salzgitter (DE); Mesut YURTSEVEN, Salzgitter (DE); Natascha VON ASPERN, Braunschweig (DE)

(73) Assignee: Volkswagen Aktiengesellschaft, Wolfsburg (DE)

(21) Appl. No.: 18/542,730

(22) Filed: Dec. 17, 2023

(30) Foreign Application Priority Data
Dec. 20, 2022 (DE) 10 2022 134 057.0

(51) Int. Cl. H01M 10/654; H01M 4/134; H01M 10/0585; H01M 50/342; H01M 50/54; H01M 50/553

(52) U.S. Cl. CPC H01M 10/654; H01M 4/134; H01M 10/0585; H01M 50/3425; H01M 50/54; H01M 50/553; H01M 2004/028

(57) ABSTRACT

A battery with a casing and a stack arranged within the casing. First electrodes and second electrodes are arranged alternately in the stack with the interposition of a separator. The first electrodes are electrically connected to a first battery terminal integrated into the casing, the second electrodes are electrically connected to a second battery terminal integrated into the casing. The electrodes each have an electrically conductive substrate and an active material layer on at least one side of the substrate. The substrates of the first electrodes and/or the second electrodes form a transverse projection on at least one side of the at least one associated active material layer. The transverse projections of the substrates of the first electrodes and/or the transverse projections of the substrates of the second electrodes are connected to a thermally conductive element. The at least one conductive element contacts the casing and/or forms a section thereof.

This nonprovisional application claims priority under 35 U.S.C. § 119(a) to German Patent Application No. 10 2022 134 057.0, which was filed in Germany on 20 Dec. 2022, and which is herein incorporated by reference.

### BACKGROUND OF THE INVENTION

### Field of the Invention

The present invention relates to a battery, in particular a battery provided as a traction battery of a motor vehicle, by means of which electrical energy can be provided for operating an electric traction motor of the motor vehicle.

### Description of the Background Art

A battery is an electrochemical-based storage device for electrical energy during the discharge of which stored chemical energy is converted into electrical energy by an electrochemical redox reaction. In the context of the invention, batteries are understood to mean both so-called primary batteries, which are only intended for one-time discharging and not for recharging, and so-called secondary batteries or accumulators, which are intended for multiple charging and are designed accordingly. Charging a secondary battery represents the electrolytic reversal of the electrochemical redox reaction which takes place during discharge, and which is realized by applying an electrical voltage.

A battery comprises one or typically multiple battery elements arranged within a casing, usually in the form of a foil casing or housing, often referred to as a “pouch.” The battery elements each comprise two electrodes, a separator arranged between the electrodes for electrically separating the electrodes, and an electrolyte serving as an ionic conductor. The two electrodes of a battery element differ in terms of the active material they each contain, whereby one of the electrodes is anodically active and the other is cathodically active (in each case related to a discharging of the battery cell). Furthermore, a battery usually comprises two battery terminals which are integrated into the casing, and which are electrically conductively connected to the electrodes on the inside of the casing. All anodically active electrodes can be connected to one battery terminal and all cathodically active electrodes to the other battery terminal.

A design of a battery with a housing can have the advantage of a higher structural load capacity of the battery compared to batteries with a foil casing.

Batteries and in particular the lithium-ion batteries currently mainly used as traction batteries in motor vehicles should be stored and in particular operated, i.e., charged and discharged, within a defined temperature range in order to avoid performance deficits, damage, and/or accelerated aging. Exceeding the temperature range does not have to be based exclusively on a temperature adjustment with a correspondingly high ambient temperature; rather, when charging or discharging a battery, batteries generate a significant amount of waste heat, which leads to self-heating. It can therefore be useful to control the temperature of batteries in order to avoid falling below or exceeding the temperature range. In the case of traction batteries of motor vehicles, such temperature control is usually carried out by integrating the traction batteries into a motor vehicle cooling system by which thermal energy can be transferred to or removed from the traction batteries via a heat transfer liquid. In this case, casings or housings of individual batteries or battery modules, which being connected into a so-called battery stack form a traction battery, are usually temperature-controlled. However, a large number of individual battery cells are usually arranged in a stack within the casings. It follows that temperature control via the casing is more effective for elements of the stack that are located relatively close to the casing and the temperature control effect decreases significantly towards the center within the casing.

U.S. Pat. No. 6,858,344 B2 discloses a battery with a rectangular housing made of plastic, in the large faces of which metal plates are embedded, wherein a contact section of these plates protrudes from the housing and is provided for contact with a cooling element through which a coolant flows. By integrating the plates into the housing, better heat conduction via the housing should be realized.

U.S. Pat. No. 10,686,170 B2 describes a stacked arrangement of batteries with foil casings in a housing, wherein the foil casings are connected on at least two sides with a strip-shaped retaining element, wherein the retaining elements are intended to enable secure mounting of the stacked batteries in a housing.

U.S. Pat. No. 6,709,783 B2 discloses a battery stack with multiple stacked batteries, wherein cooling elements, which form a plurality of cooling channels for a cooling medium to flow through, are arranged between the batteries.

### SUMMARY OF THE INVENTION

It is therefore an object of the present invention to realize the most advantageous temperature control possible for a battery.

According to an example of the invention, a battery is provided, in particular a traction battery for a motor vehicle and/or a lithium-ion battery, with a preferably rectangular casing and with a stack, arranged within the casing, with a plurality of first electrodes and a plurality of second electrodes, which are arranged alternately in the stack with the interposition of a separator in each case. The casing preferably completely surrounds the stack with the electrodes and separators and is further preferably designed to be gas-tight (in a usable state).

The first electrodes are electrically conductively connected to a first battery terminal, which is integrated into the casing, preferably into a first end face of the casing, and the second electrodes are electrically connected to a second battery terminal, which is also integrated into the casing, preferably into a second end face of the casing. The electrodes each have an electrically conductive substrate, in particular designed as a film, and on at least one side of the substrate a preferably prismatic, particularly preferably rectangular, active material layer. The active material layer can have a very small height (layer thickness) compared to a length and width. In the case of the preferably provided rectangular active material layers, (substantially) a rectangular shape can also result for the stack. For this purpose, the separators can also be designed to be rectangular, wherein the large sides are preferably slightly larger than the large sides of the active material layers, between which the separators are arranged in a separating manner. The electrical connections between the electrodes and the battery terminals and also the substrates each serve to conduct electricity with as little resistance as possible and are therefore preferably designed such that they have the lowest possible specific resistance (e.g., a maximum of 1 Ω*mm²/m at 20° C.). The substrates of the first electrodes and/or the second electrodes form a transverse projection on at least one side, in particular on a long side, of the respective active material layer; i.e., they project in the transverse direction or along the width beyond the dimensions of the respective active material layer.

The transverse projections of the substrates (only) of the first electrodes (i.e., not also of the second electrodes) and/or the transverse projections of the substrates (only) of the second electrodes (i.e., not also of the first electrodes) are (possibly each) connected to an at least thermally conductive element, wherein the at least one conductive element contacts the casing and/or forms a section thereof or is integrated into it. For example, a thermal conductivity of at least 5 W/(m·K) is considered thermally conductive, wherein preferably a thermal conductivity of the conductive element of at least 50 W/(m·K) or at least 100 W/(m·K) or at least 200 W/(m·K) is realized (in each case at 20° C. and 50% humidity). Metals and in particular aluminum, from which the at least one conductive element is preferably at least partially made, are generally considered to be thermally conductive within the context of the invention.

A rectangle and thus also a rectangular casing as well as a rectangular active material layer have a length, width, and height, wherein according to the invention, the length is the largest (edge) dimension, the width is the middle (edge) dimension, and the height is the smallest (edge) dimensions (if, as is preferably provided, there are corresponding differences). A rectangle then comprises two large sides, which are spanned by the length and the width, two long sides, which are spanned by the length and the height, and two end faces, which are spanned by the width and the height. According to the invention, a rectangle can also be considered a shape that does not exactly correspond to a geometric rectangle due to manufacturing-related deviations.

A battery of the invention is characterized by good temperature controllability via the at least one conductive element, which in the preferably provided arrangement can be designed to have a relatively large area overall on the long sides of the active material layers and thus also on the long side of the stack with the electrodes and separators. The relatively good temperature controllability can have an advantageous effect with regard to the performance and/or the service life of the battery. Furthermore, this enables a compact design of the battery.

The casing can preferably be designed as a dimensionally stable housing. A housing is considered “dimensionally stable” if its three-dimensional shape does not collapse due to its own weight force without an external load. Preferably, such a housing can be designed to be dimensionally stable such that it does not collapse when exposed to external forces that occur during normal use and, particularly preferably, is also not deformed to a relevant extent (“rigid” housing). The housing can also preferably be made entirely or partially of metal, for example, aluminum, whereby a dimensionally stable and also good thermally conductive housing can be realized relatively easily and inexpensively.

According to an example of a battery of the invention, it can be provided that the at least one conductive element is electrically connected to an associated battery terminal. This connection also serves to conduct electricity with as little resistance as possible and is therefore preferably designed such that it results in the lowest possible specific resistance (e.g., of a maximum of 1 Ω*mm²/m at 20° C.). This example of a battery of the invention can have particular advantages with regard to the manufacturability of the battery and specifically the manufacturability of the electrodes. This applies in particular if, as is preferably provided, the corresponding conductive element integrates the associated battery terminal. The provided integration of the battery terminal into the casing then emerges as part of the battery assembly process. For this purpose, it can be provided that an assembly, which, on the one hand, comprises the stack with the electrodes and separators and optionally further components, such as, for example, at least one deformation element, and, on the other hand, the at least one conductive element, is introduced into a basic housing of a casing designed as a housing. The at least one conductive element can already be connected to the associated electrodes. The basic housing can have a corresponding insertion opening for introducing the assembly. This insertion opening can then be closed using a housing cover. Integration of the battery terminal into the housing can then preferably be achieved by the battery terminal protruding through a through opening in the housing cover after the housing cover has been mounted.

According to an example in which the at least one conductive element is electrically connected to an associated battery terminal, it can further be provided that the at least one conductive element comprises a first subelement, which is electrically connected to the associated battery terminal, and an at least partially electrically insulating second subelement, which bridges a distance between the first subelement and the casing. A component is considered electrically insulating if a relevant current flow across it is prevented despite an existing electrical potential difference. As a result, an electrical connection between the conductive element and specifically the electrically conductive first subelement thereof, on the one hand, and the casing, on the other hand, can be prevented, although the conductive element is electrically connected to the associated battery terminal. This can be advantageous in terms of safety when using such a battery. An advantageous dissipation of thermal energy from the stack with the electrodes and separators to or via the casing can still be realized via the second subelement.

Preferably, it can be provided that the conductive element is arranged partially in a through opening of the casing. This makes it possible to realize particularly good temperature control for the stack with the electrodes and separators because a direct heat exchange between the conductive element and the environment can be realized. It can then be provided particularly preferably that the conductive element comprises a first section, which is arranged in the through opening of the casing and preferably does not contact the casing, and a second section, which contacts the casing on the inside, is designed to be electrically insulating or to have a high resistance, and/or seals against a gas passage. This makes it possible to design the first section from a thermally conductive material, which is often also electrically conductive, and in particular a metal, preferably aluminum, wherein a (low-resistance) electrical connection between this first section and the casing can be avoided. At the same time, the second section of the conductive element can ensure sufficient sealing of the casing in the area of the through opening and/or sufficient support of the conductive element on the casing.

The substrates of the first electrodes can form a longitudinal projection on one side, preferably an end face, of the respective associated (preferably rectangular) active material layer (i.e., they protrude in a longitudinal direction beyond the dimensions of the respective active material layer), wherein the longitudinal projections of the substrates (only) of the first electrodes are connected to the first battery terminal. Alternatively or additionally, the substrates of the second electrodes can also form a longitudinal projection on one side, preferably an end face, of the associated (preferably rectangular) active material layer, wherein the longitudinal projections of the substrates (only) of the second electrodes are connected to the second battery terminal. An electrical connection between the electrodes and the associated battery terminal can therefore also be realized directly, i.e., not via the at least one conductive element. As a result, an advantageous structural design of the at least one conductive element can be realized if possible.

In a battery of the invention, which can be characterized by a particularly simple structural design, it can be provided that the substrates of the first electrodes form a transverse projection on two long sides of the associated active material layers, wherein these transverse projections on both sides are each connected to the conductive element or to one conductive element. The substrates of the second electrodes, in contrast, can each form a longitudinal projection and be connected directly to the second battery terminal. Particularly preferably (and also in principle) it can be provided that the first electrodes have a cathode active material and/or a substrate made of aluminum. The second electrodes, in contrast, can have an anode active material and/or a substrate made of copper or aluminum.

The at least one conductive element of a battery of the invention can preferably be designed to be rigid. The at least one conductive element is considered to be “rigid” if it does not deform to a relevant extent (i.e., to a recognizable and function-influencing extent) under the loads that act on it during the intended use. As a result, the conductive element can advantageously influence the stability of the stack of electrodes and separators or an assembly comprising these components. This can have a particularly advantageous effect when assembling a battery of the invention.

For the same reason, it can be provided that the at least one conductive element covers an assigned side, in particular the long side of the stack, by at least 50% or at least 75%.

In particular, with such a relatively large-area design of the at least one conductive element, it can further preferably be provided that it has at least one through opening. On the one hand, this can have an advantageous effect with regard to the lowest possible mass of the conductive element and thus the mass of the battery as a whole. In addition, such a through opening can have an advantageous effect with regard to the distribution of an electrolyte within the casing. As part of the production of a battery of the invention, it can be provided to introduce the electrolyte into the casing after an assembly, which comprises at least the stack with the electrodes and separators and the at least one conductive element, has been introduced into the casing. For this purpose, the casing can have a corresponding filling opening. In particular, it can also be provided that the casing has a filling opening and/or integrates a pressure relief valve in a section of its side, preferably the long side, which adjoins the at least one conductive element. Such a pressure relief valve can serve to relieve excess pressure that has developed during use of the battery as a result of damage that leads to gas development. The preferably provided at least one through opening of the conductive element can advantageously enable the gas to be discharged to the pressure relief valve. Such a pressure relief valve can use a passage opening that also serves as a filling opening. According to an example, such a pressure relief valve can be designed as a burst valve, which specifically fails when a defined overpressure is reached and is destroyed in the process. In particular, such a burst valve can be designed as a burst film which, in an intact state, covers a passage opening in the casing.

For the safest possible use of a battery of the invention, it can be provided that at least one of the battery terminals is electrically insulated from the casing, so that no current can flow between these components as far as possible.

Furthermore, it can be provided that one of the battery terminals is connected to the casing in a high-resistance manner. An electrical connection that causes an ohmic resistance of between 1 kΩ and 100 MΩ is considered “high-resistance.” This makes it possible to realize electrical potential equalization between the casing and the corresponding battery terminal or the electrodes electrically connected thereto, without a relevantly large current flow occurring between these components. Corrosion of the casing, which could occur in particular due to a chemical interaction with the electrolyte contained within the casing in the event of a potential difference, can be avoided due to such a potential equalization. This applies in particular if the casing, as it is preferably provided, is made of a metal and in particular aluminum, at least on the inside. The high-resistance connection can particularly preferably be formed between the casing and the battery terminal that is electrically connected to those electrodes that have a cathode active material.

A battery of the invention can be in particular a traction battery or part of such a traction battery for a motor vehicle. By means of such a traction battery, electrical energy can be made available to an electric traction motor of the motor vehicle, which provides driving power for the motor vehicle.

According to the invention, a “film” is a body whose length and width (which limit the large areas of the film) are many times greater than its height (i.e., the thickness of the film), wherein the height can preferably correspond to a maximum of 1/100 or 1/500 or 1/1000 or 1/10,000 or 1/100,000 or 1/1,000,000 of the length and/or the width of the film. In particular, a film can be dimensioned with such a small film thickness that it would be noticeably deformed or collapsed by its own weight force if it were spread flat without support.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a battery of the invention according to an example in a longitudinal section in combination with two cooling elements;

FIG. 2 shows a top plan view of a first electrode of the battery;

FIG. 3 shows a top plan view of a second electrode of the battery;

FIG. 4 shows a stack with the battery's electrodes and separators in a longitudinal section;

FIG. 5 shows a basic housing of the battery in a perspective view;

FIG. 6 shows an assembly comprising the stack with the electrodes and separators and a conductive element of the battery;

FIG. 7 shows a cross section through a section of the assembly;

FIG. 8 shows the insertion of the assembly into the basic housing as part of the production of the battery;

FIG. 9 shows a battery of the invention according to an example in a longitudinal section in combination with two cooling elements;

FIG. 10 shows a top plan view of a first electrode of the battery;

FIG. 11 shows a battery of the invention according to an example in a longitudinal section combination with two cooling elements; and

FIG. 12 shows a top plan view of a second electrode of the battery.

### DETAILED DESCRIPTION

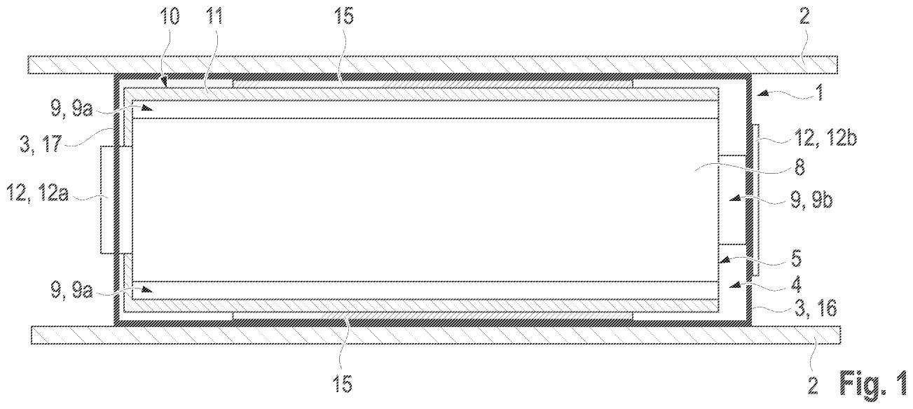

FIG. 1 shows a battery 1 of the invention in combination with two cooling elements 2. The cooling systems contact battery 1, which has a casing in the form of a rectangular housing 3, on one long side each. Cooling elements 2 can, for example, be integrated into a cooling system in which a coolant circulates. In this regard, the coolant can also flow through cooling elements 2 themselves. By means of the cooling elements, an advantageous temperature control of the battery shown or of a number of such batteries can be realized. It can be provided that a cooling element 2 each is arranged between two batteries 1 of the invention.

The battery 1 shown comprises, in addition to housing 3, a stack 4 with electrodes 5 and separators 6 which is arranged within housing 3, as shown in further detail in FIG. 4. Whereas in FIG. 4 a stacking direction of stack 4 runs parallel to the drawing plane, in FIG. 1 it is oriented perpendicular with respect to the drawing plane.

Stack 4 comprises, in alternating order, the rectangular, thin (i.e., designed with a low height) electrodes 5 and separators 6 likewise designed as rectangular, thin, and electrically insulating. Electrodes 5 are in turn present in stack 4 alternately as first electrodes 5a, which act as cathodes when battery 1 is discharged, and as second electrodes 5b, which act as anodes when battery 1 is discharged. Separators 6 can be designed so that they also serve as a solid electrolyte, or they are impregnated with a liquid electrolyte when battery 1 is in a usable state. The centered stacking of rectangular electrodes 5 and separators 6 results in a stack 4, which also has an approximately rectangular shape adapted to the rectangular shape of housing 3. In this regard, small projections between the various elements of stack 4 and in particular a peripherally slightly larger design of separators 6 compared to electrodes 5 are intentionally provided in order to ensure sufficient separation of electrodes 5 even in the event of imprecisions in the stacking of these elements.

Electrodes 5 each comprise a film-like substrate 7 made of an electrically conductive material, for example, a metal, which is provided in a section on both sides with a layer of an anode or cathode active material (active material layers) 8, whereas at least one uncoated section of each substrate 7 each represents an arrester associated with the respective electrode 5. Such an uncoated section of each substrate 7 represents a projection 9 with respect to the associated active material layers 8. Substrate 7 of first electrodes 5a can preferably be made of aluminum, whereas substrate 7 of second electrodes 5b can preferably be made of copper and/or nickel and/or aluminum.

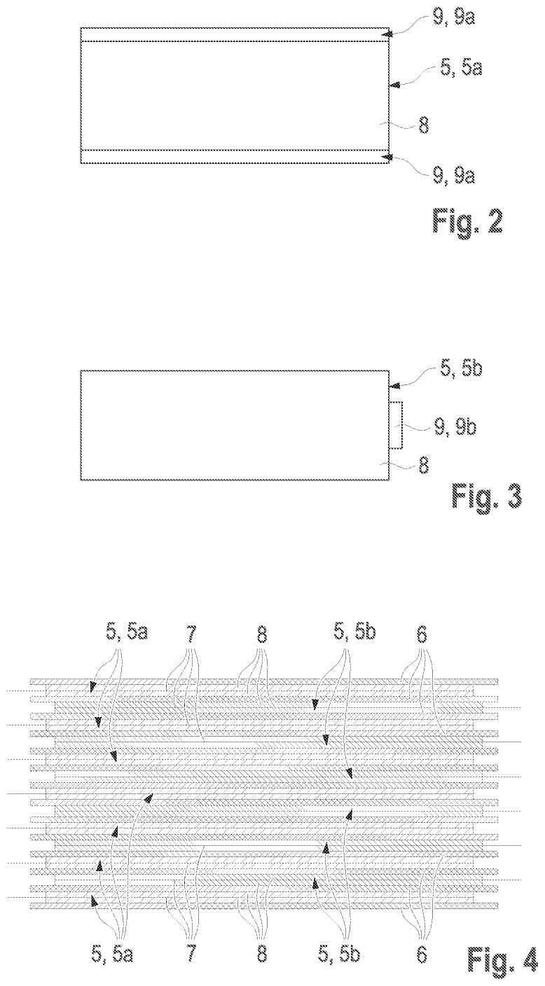

Substrates 7 of first electrodes 5a each form a transverse projection 9a on both of their long sides of the associated active material layers 8, wherein these transverse projections 9a each extend over the entire length of first electrodes 5a (cf. also FIG. 2). Substrates 7 of second electrodes 5b, in contrast, only form a longitudinal projection 9b on one end face, which does not extend over the entire width of the respective second electrode 5b (cf. FIG. 3).

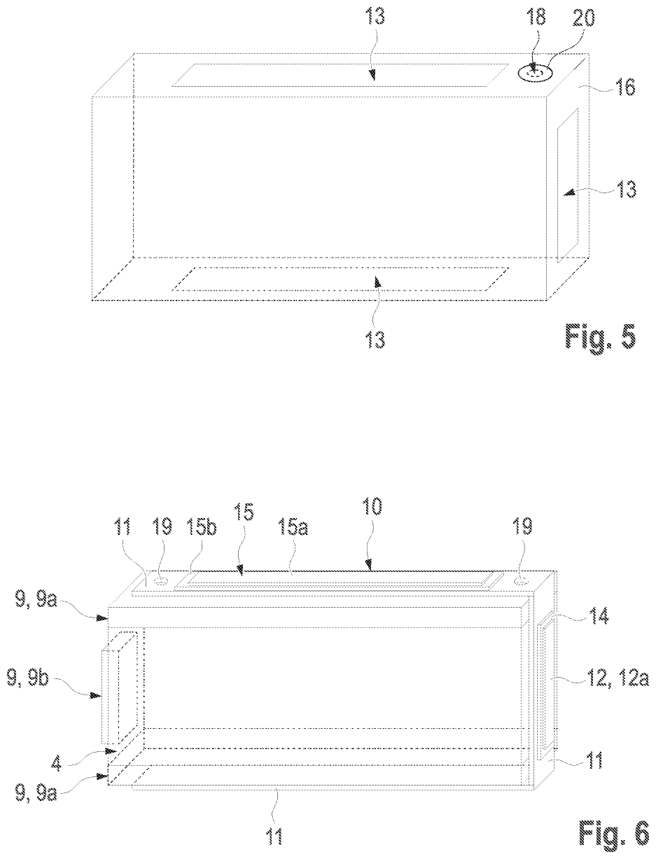

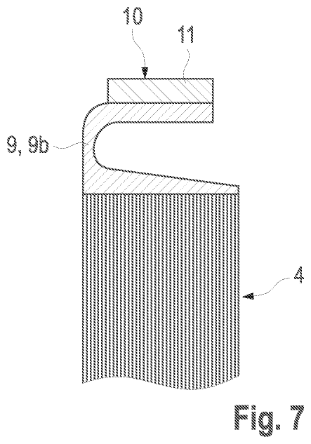

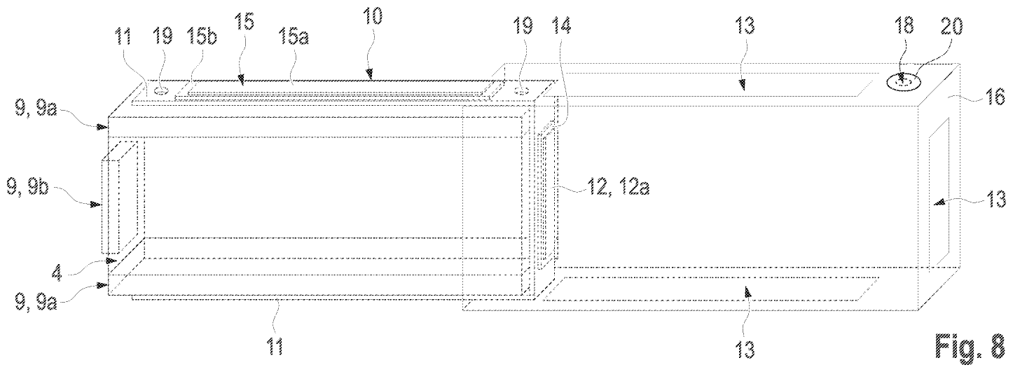

Transverse projections 9a on both sides of all of the first electrodes 5a are fixedly connected in groups to a conductive element 10 (cf. FIG. 7). This conductive element 10 is shown in more detail in FIG. 6. The connection between transverse projections 9a and conductive element 10 can be realized in particular in an integrally bonded manner, for example, by welding. Conductive element 10 comprises a U-shaped first subelement 11, which can be made (optionally in several parts) entirely of metal, in particular aluminum. This first subelement 11 serves primarily as an electrical conductor and for this purpose electrically connects transverse projections 9b on both sides of substrates 7 of first electrodes 5a with a first (12a) of two battery terminals 12 of battery 1. First battery terminal 12a is an integral part of conductive element 10 or this is already fixedly connected to first subelement 11 of conductive element 10 before it is introduced into housing 3 in combination with stack 4 (cf. FIG. 8). After the corresponding assembly, which comprises stack 4 with electrodes 5 and separators 6 as well as conductive element 10, has been introduced into housing 3, the first battery terminal 12 protrudes through a passage opening 13 of housing 3, which opening is slightly larger on the periphery (cf. FIGS. 5 and 8), but without directly contacting housing 3. A frame-shaped sealing element 14, which surrounds first battery terminal 12a, ensures that the gap is sealed, which is formed on the periphery of this through opening between housing 3 and first subelement 11 of the conductive element.

Conductive element 10 further comprises two second subelements 15, each of which is fixedly connected with direct contact to a section of first subelement 11 which covers one of the long sides of stack 4. Second subelements 15 each comprise a first section 15a, which can preferably be made of metal and in particular of aluminum and which contacts first subelement 11 directly. Similar to first battery terminal 12a, first section 15a of each second subelement 15 of conductive element 10 projects into a peripherally slightly larger dimensioned through opening 13 of housing 3 without directly contacting it. A frame-shaped second section 15b of each of the second subelements 15 ensures that the gap is sealed, which is formed on the periphery of the associated through opening 13 between housing 3 and first subelement 11 of the conductive element, and thereby bridges a distance between first subelement 11 of conductive element 10 and housing 3.

In principle, first sections 15a of second subelements 15 of conductive element 10, which sections are accessible from the outside due to their arrangement within a through opening 13 of housing 3, could also serve as (first) battery terminals 12a of the battery. However, these are used exclusively as thermal conductors, which enable good conduction of thermal energy from battery 1 or into battery 1 (for heating if necessary) through direct contact with one of the cooling elements 2. The large-area contact of substrates 7 of first electrodes 5a with conductive element 10 ensures good heat conduction from or into the interior of stack 4.

Both sealing element 14 surrounding first battery terminal 12a and second sections 15b of second subelements 15 of conductive element 10 are each made of either an electrically insulating material or a high-resistance material. A high-resistance design for at least one of these elements is preferred in order to realize electrical potential equalization between first electrodes 5a and housing 3. As a result, corrosion of housing 3 due to an electrochemical interaction with the electrolyte can be avoided.

Conductive element 10 and specifically the rigidly designed first subelement 11 thereof cover the adjacent longitudinal and end faces of stack 4 by at least 50%. As a result, conductive element 10 can advantageously stabilize stack 4 with electrodes 5 and separators 6 when battery 1 is assembled. In addition, this can advantageously serve as a guide element during introduction of the assembly with these components into housing 3. Such an introduction can take place according to FIG. 8 by inserting the assembly into a basic housing 16 of housing 3, which is designed to be open on one of its end faces. Conductive element 10 or specifically the outer sides of first sections 15a of second subelements 15 can contact basic housing 16 on the inside or slide along it in order to serve as a guide element. The open end face of basic housing 16 is closed by means of a housing cover 17 after introduction of the assembly with stack 4 and conductive element 10.

After housing 3 is closed by means of housing cover 17, it can be provided to introduce the electrolyte into housing 3. For this purpose, housing 3 can have a corresponding filling opening 18 (cf. FIGS. 5 and 8) on one of its long sides. After the electrolyte is introduced, this filling opening 18 can be closed. For this purpose, for example, a film 20 covering filling opening 18 can be attached integrally bonded to the housing. This film can be designed further such that it tears when a defined overpressure is reached within housing 3 and consequently forms a pressure relief valve.

In order to ensure good distribution of the electrolyte introduced into housing 3 via filling opening 18, conductive element 10 has a plurality of through openings 19 at least in the section adjoining the long side of housing 3, said side that integrates filling opening 18. Separators 6 are impregnated with the electrolyte. This causes them to swell to a certain extent, which increases the dimensions of stack 4. This applies in particular to the height of stack 4, but also to a lesser extent to the length and width. This increase in the dimensions of stack 4 ensures that the stack 4 is received substantially without play within housing 3 and also ensures that second sections 15b of second subelements 15 are arranged in the corresponding housing openings 13.

The longitudinal projections 9b of substrates 7 of all second electrodes 5b are grouped and electrically connected to a second battery terminal 12b of battery 1. This second battery terminal 12b can be fixedly integrated into housing cover 17, wherein electrical insulation is provided between second battery terminal 12b and housing cover 17.

The electrical connection between the longitudinal projections 9b of substrates 7 of second electrodes 5b and second battery terminal 12b can be made as part of the assembly process of battery 1 after the assembly with stack 4 and conductive element 10 is introduced into basic housing 16 and before housing cover 17 is attached. For this purpose, longitudinal projections 9b of substrates 7 and second battery terminal 12b can preferably be connected to one another in an integrally bonded manner, for example, welded.

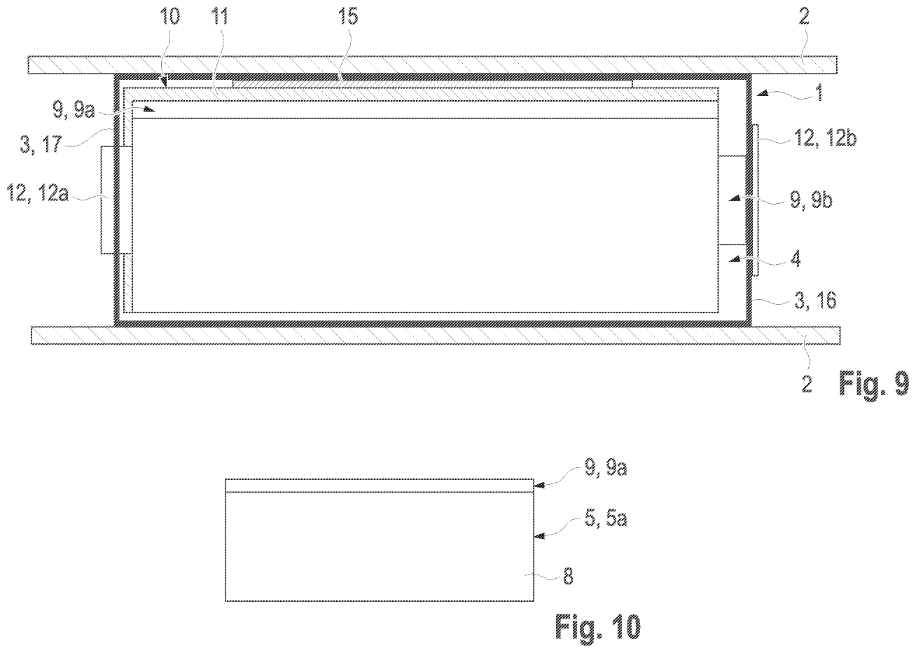

FIG. 9 shows an example of a battery 1 of the invention, which differs from that according to FIG. 1 in that conductive element 10 and specifically the first subelement 11 thereof are made L-shaped. In keeping with this, substrates 7 of first electrodes 5a only on one of their long sides form transverse projections 9a (cf. also FIG. 10), which are connected to conductive element 10.

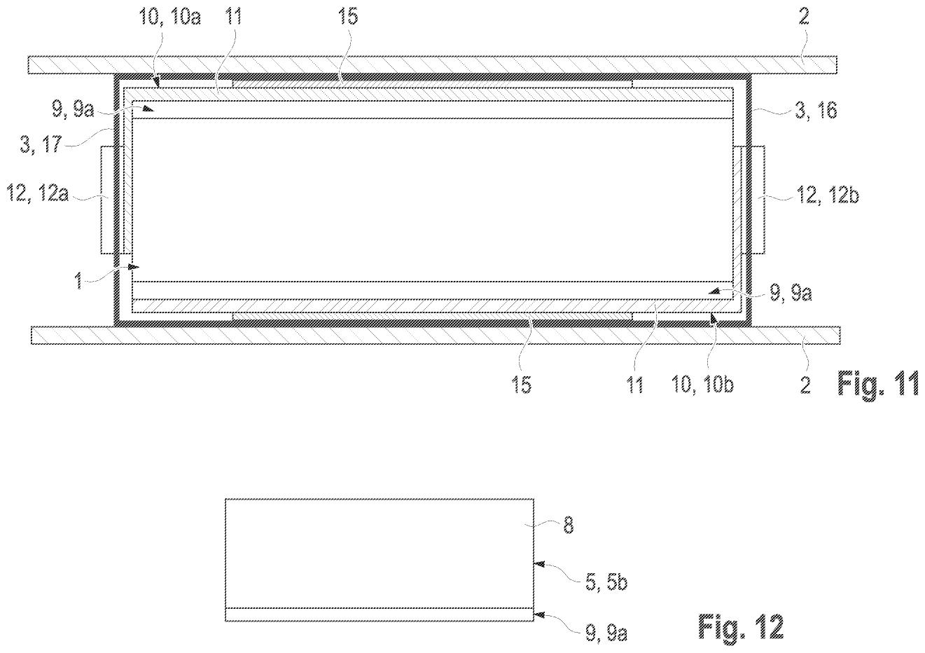

Battery 1 of the invention according to FIG. 11 comprises two L-shaped conductive elements 10, of which a first element (10a) according to FIG. 9 is connected to transverse projections 9a, which form substrates 7 of first electrodes 5a on one of their long sides. Comparably to this, in the battery according to FIG. 11, substrates 7 of second electrodes 5b also form a transverse projection 9a on one long side (cf. FIG. 12), wherein transverse projections 9a of first electrodes 5a, on the one hand, and second electrodes 5b, on the other hand, are arranged on opposite long sides of electrodes 5 or stack 4 with electrodes 5 and separators 6. Transverse projections 9a of second electrodes 5b are connected to a second element (10b) of conductive elements 10. This second conductive element 10b can structurally correspond to first conductive element 10a and can also integrate second battery terminal 12b. If necessary, these can also differ at least in terms of the materials used. For example, it can be provided that at least first subelement 11 of second conductive element 10b is made of copper, whereas first subelement 11 of first conductive element 10a can be made of aluminum.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery comprising:
a casing;
a stack arranged within the casing;
at least two first electrodes and at least two second electrodes, the at least two first and second electrodes being are arranged alternately in the stack, the at least two first electrodes are electrically connected to a first battery terminal, which is integrated into the casing, and the at least two second electrodes are electrically connected to a second battery terminal, which is integrated into the casing; and
a separator arranged between each of the alternately arranged at least two first and at least two second electrodes,
wherein the at least two first and at least two second electrodes each have an electrically conductive substrate and an active material layer on at least one side of the substrate,
wherein the substrate of the first electrodes and/or the second electrodes form a transverse projection on at least one side of the at least one associated active material layer,
wherein the transverse projections of the substrates of the at least two first electrodes and/or the transverse projections of the substrates of the at least two second electrodes are connected to at least one thermally conductive element, and
wherein the at least one thermally conductive element contacts the casing and/or forms a section thereof.

2. The battery according to claim 1, wherein the at least one conductive element is electrically connected to an associated battery terminal.

3. The battery according to claim 2, wherein the at least one conductive element integrates the associated battery terminal.

4. The battery according to claim 2, wherein the at least one conductive element comprises a first subelement, which is electrically connected to the associated battery terminal, and comprises a second subelement, which is at least partially electrically insulating or has high-resistance effect and which bridges a distance between the first subelement and the casing.

5. The battery according to claim 1, wherein the conductive element is arranged partially in a through opening of the casing.

6. The battery according to claim 5, wherein the conductive element comprises a first section, which is arranged in the through opening of the casing, and a second section which contacts the casing on the inside, and comprises an electrically insulating or high-resistance effect, and/or seals against a gas passage.

7. The battery according to claim 1, wherein the substrates of the first electrodes form a longitudinal projection on one side of the at least one associated active material layer, the longitudinal projections of the substrates of the first electrodes being electrically connected to the first battery terminal, which is integrated into an adjacent end face of the casing, and/or wherein the substrates of the second electrodes form a longitudinal projection on one side of the at least one associated active material layer, the longitudinal projections of the substrates of the second electrodes being electrically connected to the second battery terminal, which is integrated into an adjacent end face of the casing.

8. The battery according to claim 7, wherein the substrates of the first electrodes form a transverse projection on two long sides of the at least one associated active material layer, wherein the transverse projections are connected to the conductive element or to one conductive element, and the substrates of the second electrodes form the longitudinal projection.

9. The battery according to claim 1, wherein the first electrodes have a cathode active material and/or a substrate made of aluminum.

10. The battery according to claim 1, wherein the at least one conductive element is rigid.

11. The battery according to claim 1, wherein the at least one conductive element covers an assigned side of the stack by at least 50% or at least 75%.

12. The battery according to claim 1, wherein the at least one conductive element has at least one through opening.

13. The battery according to claim 1, wherein the casing has a filling opening in a section that adjoins the at least one conductive element and/or integrates a pressure relief valve.

14. The battery according to claim 1, wherein at least one of the battery terminals is electrically insulated from the casing.

15. The battery according to claim 1, wherein at least one of the battery terminals is connected to the casing in a high-resistance manner.
